(19) United States
(12) Patent Application Publication
(10) Pub. No.: US 2014/0215268 A1
(43) Pub. Date: Jul. 31, 2014

(54) UNIT UNDER TEST AUTOMATION

(71) Applicant: HEWLETT-PACKARD DEVELOPMENT COMPANY, L.P., Houston, TX (US)

(72) Inventors: Niels E. Larsen, Roseville, CA (US); Bema Yeo, Roseville, CA (US); Sung Oh, Roseville, CA (US); John Jemiolo, Townsend, MA (US); Craig Hunter, Rocklin, CA (US)

(73) Assignee: Hewlett-Packard Development Company, L.P., Houston, TX (US)

(21) Appl. No.: 13/751,353

(22) Filed: Jan. 28, 2013

(51) Int. Cl. G06F 11/22

(52) U.S. Cl. CPC G06F 11/2205
USPC 714/27

(57) ABSTRACT

Unit under test automation can include receiving information relating to a system architecture, determining a number of modules to execute within a test executive, and implementing a unit under test utilizing the number of determined modules.

### BACKGROUND

Assembling a system architecture can include a manual assembly of physical hardware (e.g., servers, cable connections, displays, etc.). Validation of the system architecture can include, but is not limited to: validating that the physical hardware is connected properly, validating that the software and/or firmware is updated, and/or validating that software is operational. Validation of the system architecture can include performing a number of units under test (UUT).

### BRIEF DESCRIPTION OF THE DRAWINGS

FIG. 1 illustrates a diagram of an example of an environment for unit under test automation according to the present disclosure.

FIG. 2 illustrates a flow chart of an example of a method for unit under test automation according to the present disclosure.

FIG. 3 illustrates a block diagram of an example of a system according to the present disclosure.

### DETAILED DESCRIPTION

Unit under test (UUT) automation can be performed by an automation test executive as described herein. The automation test executive can include a plurality of modules to perform a unit under test for a variety of system architecture designs. For example, the automation test executive can include modules capable of performing a unit under test for a first system architecture design and also modules capable of performing a unit under test for a second system architecture design with different features (e.g., system hardware, design, capabilities, etc.) from the first system architecture design.

The automation test executive can determine features (e.g., hardware features, software features, firmware features, etc.) of customer's system architecture. The automation test executive can use the number of determined features to determine a number of modules from the plurality of modules to use for the unit under test automation.

The automation test executive can be connected to the unknown customer's system architecture via a computing console (e.g., via an integrated lights out (iLO) management functionality, etc.). The automation test executive can determine features of a customer's system architecture via the connection. By automatically determining a number of modules to perform a unit under test, the automation test executive can automatically test a customer's system architecture without configuring a testing system with modules based on the features of the customer's architecture. The automation test executive can increase consistency and predictability of the unit under test while lowering attended time and required skill of operators.

The unit under test automation as described herein can support a greater number of unit under test processes by connecting the automation test executive to a number of devices and/or by performing the described enhancements.

In the following detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

As used herein, “a” or “a number of” something can refer to one or more such things. For example, “a number of articles” can refer to one or more articles.

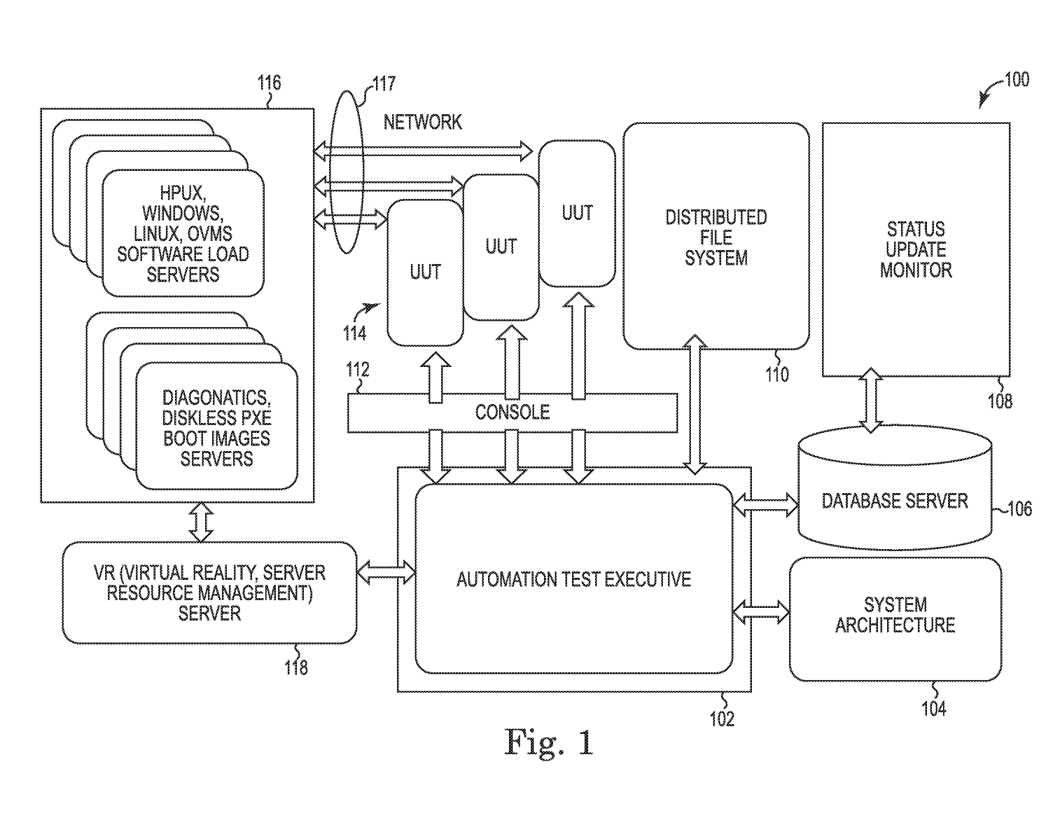

FIG. 1 illustrates a diagram of an example of an environment 100 for unit under test automation according to the present disclosure. The environment 100 can include a number of components to automatically perform a unit under test for a system architecture 104. The system architecture 104 can be a customer's system architecture that is a recently connected computing system (e.g., hardware recently connected, new server computing system, recently manufactured computing system architecture, etc.).

An automation test executive 102 can include a number of modules that can be used to generate a unit under test (e.g., UUT 114, etc.). The number of modules can perform and/or designate a number of functional and/or performance tests for the system architecture 104. For example, the unit under test can be a performance test of a particular memory resource (e.g., unit, etc.) within a system architecture 104. The functional and/or performance tests to perform a unit under test of the system architecture 104 can be used to determine if the system architecture 104 is performing at a particular level of functionality (e.g., system specification level of functionality, performing to industry standards, performing to desired functionality, etc.).

The automation test executive 102 can be connected to a number devices to perform the unit under test automation process on a system architecture 104. The automation test executive 102 can be connected to a system architecture 104 via a communication link (e.g., path, network connection, hardware, etc.). The automation test executive 102 can determine information relating to the system architecture 104. For example, the automation test executive 102 can utilize the communication link to determine hardware features and architecture of the hardware features for the system architecture 104. That is, the automation test executive 102 can determine the hardware features and architecture of the hardware within the system architecture 104.

The automation test executive 102 can be connected to a console 112 (e.g., an integrated lights out (iLO) management functionality, server management chip, etc.). The console 112 can be connected to a number of unit under test processes 114. The automation test executive 102 can send and receive test information for the unit under test processes 114 via the console and communication links.

The test information can include the determined features of the system architecture. That is, the automation test executive 102 can determine the features of the system architecture 104, determine a number of modules to perform the unit under test for the system architecture, and send the test information that includes the features of the system architecture and the number of modules to perform the unit under test processes 114.

The test information can be used by a load provider 116. The load provider 116 can include software load servers and/or boot image servers to provide a load and/or diagnostic information for each of the unit under test processes 114. The load provider 116 can utilize a network 117 to perform the unit under test processes 114. The number of unit under test processes 114 can be increased via implementing a 64 bit operating system compared to implementing a 32 bit operating system for the load provider 116 and/or automation test executive 102.

The load provider 116 can be connected to a virtual reality server 118. The virtual reality server 118 can utilize cloud computing techniques to provide increased bandwidth for performing the unit under test processes 114. The virtual reality server can provide load balancing of the load provider 116. Load balancing the load provider can increase (e.g., maximize, etc.) the load provider 116 server's allocation to the unit under test processes 114.

The load provider 116 can be provided with a number of enhancements to optimize a number of features. For example, the enhancements to the load provider can provide 10 gigabytes (GB) of input/output (IO) speed which delivers approximately 400 Megabytes (MB) per second access speed on networked based distributed file system (e.g., distributed file system 110, network file system, management server, etc.). The enhancements can include having the load provider 116 under a hardware cluster environment to provide redundancy, among other enhancements. For example, the hardware cluster environment can provide redundancy for the load provider 116, the automation test executive 102, the database server 106, the distributed file system 110 and/or the status update monitor 108.

The automation test executive 102 can be connected to a distributed file system 110 (e.g., network file system (NFS), management server, etc.). The distributed file system 110 can be utilized to store and/or share a number of unit under test system log files. For example, the distributed file system 110 can receive log files for events that occur when performing the unit under test processes 114. The system log files can include various events (e.g., errors, security threats, etc.) that occur during the unit under test processes 114. The distributed file system 110 can be a NFS with a mount buffer size within a particular range. For example, the NFS buffer size can be between 8 kilobytes (kbs) and 32 kbs. The distributed file system 110 can provide a detailed log of the unit under test processes 114 that can be used for an increased data mining process compared to other log file systems. For example, the distributed file system 110 can be used to collect a number of unit under test failures from the unit under test processes 114 for a given period of time.

The distributed file system 110 with a buffer size within the particular range can support a number of increased daemon calls (e.g., calling operation, etc.) compared to distributed file systems outside the particular range. For example, the distributed file system 110 within the particular range can support 32 daemon calls compared to 1 daemon call with a distributed file system outside the particular range. Writing in C++ and/or compiled executable binary based modules to communicate can enhance the performance and IP protection compared to utilizing Perl socket calls for the communication between the automation test executive 102 and the distributed file system 110. In addition, the distributed file system 110 can be enhanced to handle additional transactions. For example, if the distributed file system 110 is an NFS, the NFS can be enhanced from handling one NFS transaction, to being able to handle 32 NFS transactions.

The automation test executive 102 can be connected to a database server 106 (e.g. server utilizing Structured Query Language (SQL), SQL1, SQL2, SQL3, MS-SQL, etc.). The automation test executive 102 can send operation related data that can include real time status information of the unit under test processes 114. For example, the real time status information can include real time performance results of the unit under test processes 114. The performance results can include a performance of a unit under test from the load provided by the load provider 116. The operation related data can include a number of unit under test failures. For example, unit under test failures can be real time failures of a unit under test within the unit under test processes 114. The unit under test process 114 failures can include a miscommunication due to disconnected hardware and/or hardware failures.

Utilizing an automation test executive 102 within the environment 100 can enable a user to remotely manage unit under test processes 114 as well as providing system level support that can include an expansion of the load provider 116 without adding physical hardware. For example, a user can couple the automation test executive 102 to a system architecture 104 and the user can remotely manage the testing of the system architecture 104. In this example, the user is not required to have knowledge of the system architecture 104 prior to coupling the automation test executive 102 to the system architecture 104. That is, by enabling the automation test executive 102 to determine a number of modules to perform the unit under test processes 114 based on determined features of the system architecture 104.

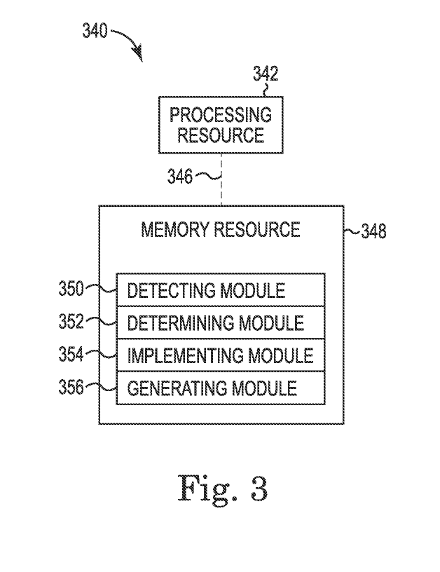

The operation related data can be displayed to a user on a status update monitor 108. The status update monitor 108 can be a display (e.g., screen, visual display, etc.) for a computing system (e.g., system 340 illustrated in FIG. 3, etc.). The real time status information of the unit under test processes 114 can be displayed at a single location on the status update monitor 108. The update monitor 108 can also include a web interface. For example, the real time status information can be sent to an operational web site interface to be accessed at a remote location.

The status update monitor 108 can be used to control the end-to-end process (e.g., beginning to end of the UUT processes 114, etc.) of the unit under test processes 114. For example, the status update monitor 108 can control the power cycle (e.g., electrical power supply, etc.) of the system 100. The status update monitor 108 can control the unit under test processes 114. For example, the status update monitor 108 can start a unit under test process 114, pause a unit under test process 114, and/or stop a unit under test process 114. The status update monitor 108 can alert a user of a failure of the unit under test process 114. In addition, the status update monitor 108 can restart a failed unit under test process 114.

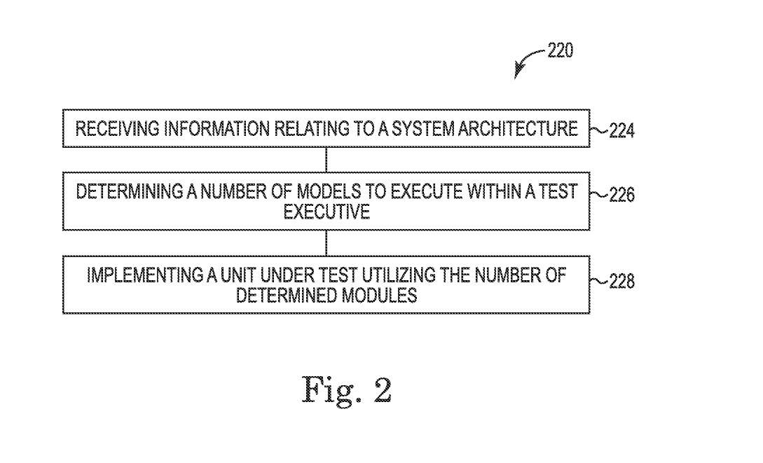

FIG. 2 illustrates a flow chart of an example of a method 220 for unit under test automation according to the present disclosure. The method 220 can allocate resources and modules to perform unit under tests for a system architecture. For example, an automation test executive as described herein can include software that can be executed to perform method 220.

At box 224 the method 220 can include receiving information relating to a system architecture. Receiving information relating to the system architecture can include determining a number of hardware features and architecture of the hardware feature of a system architecture (e.g., system architecture 104 as referenced in FIG. 1, a customer system architecture, etc.). For example, information relating to the system architecture can include specifications of hardware within the system architecture and/or include a number of connections within the architecture. The information relating to the system architecture can be received via a communication link as described herein.

At box 226 the method 220 can include determining a number of modules to execute within a test executive. Determining the number of modules to execute within a test executive can include utilizing the received architecture information to determine modules that will perform unit under tests that are specific to the system architecture. For example, modules can be implemented for a particular unit under test that are specific to a particular system architecture. That is, particular modules within the test executive can be specific to a particular hardware feature within the system architecture.

Determining the number of modules to execute within a test executive can customize a unit under test process that is specific for a variety of system architectures without having to manually customize the test executive for each system architecture.

At box 228 the method 220 can include implementing a unit under test utilizing the number of determined modules. The number of determined modules can be used to implement a unit under test for the system architecture. The determined hardware features of the system architecture can be utilized with the determined modules to perform specific units under test of the system architecture. For example, the determined hardware features can indicate a particular load to be provided for the unit under test based on a functionality of the hardware (e.g., factory specifics for capability of various hardware, etc.).

The method 220 can include implementing a number of enhancements to the test executive. The number of enhancements can include implementing a 64 bit operating system compared to a 32 bit operating system. In addition, the number of enhancements can include coupling a database to the automation test executive 102 that can support a Structured Query Language and operating system kernel turning such as an increase number of thread, larger network I/O buffer size, larger memory I/O buffer size. Additional enhancements can include adding the latest hardware drivers that are compatible with 64 bits kernel operating system. The enhancements to the test executive can also include altering the distributed file system buffer size connected to the automation test executive 102.

The unit under test can be performed utilizing an environment similar to or the same as environment 100 as referenced in FIG. 1. The method can include utilizing a status update monitor (e.g., status update monitor 108 as referenced in FIG. 1, etc.) to display real time status information relating to the unit under test of the system architecture. The real time status information can include events that relate to each unit under test for the system architecture.

FIG. 3 illustrates a block diagram of an example of a system 340 according to the present disclosure. The system 340 can utilize software, hardware, firmware, and/or logic to perform a number of functions.

The system 340 can be any combination of hardware and program instructions configured to share information. The hardware, for example can include a processing resource 342 and/or a memory resource 348 (e.g., computer-readable medium (CRM), machine readable medium (MRM), database, etc.) A processing resource 342, as used herein, can include any number of processors capable of executing instructions stored by a memory resource 348. Processing resource 342 may be integrated in a single device or distributed across multiple devices. The program instructions (e.g., computer-readable instructions (CRI)) can include instructions stored on the memory resource 348 and executable by the processing resource 342 to implement a desired function (e.g., determining features of a system architecture, etc.).

The memory resource 348 can be in communication with a processing resource 342. A memory resource 348, as used herein, can include any number of memory components capable of storing instructions that can be executed by processing resource 342. Such memory resource 348 can be a non-transitory CRM. Memory resource 348 may be integrated in a single device or distributed across multiple devices. Further, memory resource 348 may be fully or partially integrated in the same device as processing resource 342 or it may be separate but accessible to that device and processing resource 342. Thus, it is noted that the system 340 may be implemented on a user and/or a participant device, on a server device and/or a collection of server devices, and/or on a combination of the user device and the server device and/or devices.

The processing resource 342 can be in communication with a memory resource 348 storing a set of CRI executable by the processing resource 342, as described herein. The CRI can also be stored in remote memory managed by a server and represent an installation package that can be downloaded, installed, and executed. The system 340 can include memory resource 348, and the processing resource 342 can be connected to the memory resource 348.

Processing resource 342 can execute CRI that can be stored on an internal or external memory resource 348. The processing resource 342 can execute CRI to perform various functions, including the functions described with respect to FIGS. 1 and 2. For example, the processing resource 342 can execute CRI to determine a number of modules to execute within a test executive.

A number of modules 350, 352, 354, 356, can include CRI that when executed by the processing resource 342 can perform a number of functions. The number of modules 350, 352, 354, 356 can be sub-modules of other modules. For example, the detecting module 350 and the determining module 352 can be sub-modules and/or contained within the same computing device. In another example, the number of modules 350, 352, 354, 356 can comprise individual modules at separate and distinct locations (e.g., CRM, etc.).

A detecting module 350 can include CRI that when executed by the processing resource 342 can detect a number of hardware features relating to an operational system architecture. The operational system architecture can be a system architecture that is connected and ready to utilized as a system by a customer.

A determining module 352 can include CRI that when executed by the processing resource 342 can determine a number of modules to execute within a test executive based on the number of hardware features. The number of modules can be determined based on an architecture of the number of hardware features.

A implementing module 354 can include CRI that when executed by the processing resources 342 can implement a unit under test of the number of hardware features utilizing the number of determined modules. The implementing module 354 can implement the unit under test utilizing the determined hardware and system architecture.

The generating module 356 can include CRI that when executed by the processing resource 342 can generate unit under test status logs and/or provide real time status updates of the unit under test to a user. The unit under test status logs can be stored in a distributed file system server as described herein and used to provide the real time status updates on a visual display. The unit under test status logs can be stored in a NFS database and the real time status updates are stored in a database server as described herein.

A memory resource 348, as used herein, can include volatile and/or non-volatile memory. Volatile memory can include memory that depends upon power to store information, such as various types of dynamic random access memory (DRAM), among others. Non-volatile memory can include memory that does not depend upon power to store information.

The memory resource 348 can be integral, or communicatively connected, to a computing device, in a wired and/or a wireless manner. For example, the memory resource 348 can be an internal memory, a portable memory, a portable disk, or a memory associated with another computing resource (e.g., enabling CRIs to be transferred and/or executed across a network such as the Internet).

The memory resource 348 can be in communication with the processing resource 342 via a communication link (e.g., path) 346. The communication link 346 can be local or remote to a machine (e.g., a computing device) associated with the processing resource 342. Examples of a local communication link 346 can include an electronic bus internal to a machine (e.g., a computing device) where the memory resource 348 is one of volatile, non-volatile, fixed, and/or removable storage medium in communication with the processing resource 342 via the electronic bus.

The communication link 346 can be such that the memory resource 348 is remote from the processing resource (e.g., 342), such as in a network connection between the memory resource 348 and the processing resource (e.g., 342). That is, the communication link 346 can be a network connection. Examples of such a network connection can include a local area network (LAN), wide area network (WAN), personal area network (PAN), and the Internet, among others. In such examples, the memory resource 348 can be associated with a first computing device and the processing resource 342 can be associated with a second computing device (e.g., a Java® server). For example, a processing resource 342 can be in communication with a memory resource 348, wherein the memory resource 348 includes a set of instructions and wherein the processing resource 342 is designed to carry out the set of instructions.

As used herein, “logic” is an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processor.

The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A method for unit under test automation, comprising:
receiving information relating to a system architecture;
determining a number of modules to execute within a test executive based on the received information; and
implementing a unit under test utilizing the number of determined modules.

2. The method of claim 1, wherein information relating to the system architecture includes determining hardware features of the system architecture.

3. The method of claim 2, wherein determining the number of modules includes selecting modules to test the determined hardware features of the system architecture.

4. The method of claim 1, comprising logging unit under test data utilizing a database server connected to the test executive.

5. The method of claim 1, comprising implementing a number of enhancements to the test executive and load provider.

6. A non-transitory computer-readable medium storing a set of instructions executable by a processor to cause a computer to:
detect a number of hardware features relating to a system architecture;
determine a number of modules to execute within a test executive based on the number of hardware features; and
implement a unit under test of the number of hardware features utilizing the number of determined modules.

7. The medium of claim 6, wherein the test executive includes modules for a number of possible system architectures.

8. The medium of claim 6, wherein the test executive includes a number of support servers.

9. The medium of claim 6, wherein the number of support servers include a distributed file system server and a database system server.

10. The medium of claim 6, wherein the test executive is connected to a status update monitor for providing a unit under test status for a user.

11. The medium of claim 6, wherein the test executive receives diagnostic information from an operational system architecture.

12. A system for threat exchange information protection, the system comprising a processing resource in communication with a non-transitory computer readable medium, wherein the non-transitory computer readable medium includes a set of instructions and wherein the processing resource is designed to carry out the set of instructions to:
detect a number of hardware features relating to an operational system architecture;
determine a number of modules to execute within a test executive based on the number of hardware features;
implement a unit under test of the number of hardware features utilizing the number of determined modules;
generate unit under test status logs; and
provide real time status updates of the unit under test to a user.

13. The computing system of claim 12, wherein the unit under test status logs are stored in a distributed file system server and used to provide the real time status updates and testing control via a web interface.

14. The computing system of claim 12, wherein the number of modules are determined based on an architecture of the number of hardware features.

15. The computing system of claim 12, wherein the unit under test status logs are stored in a first database and the real time status updates are stored in a second database.
